(19) United States
(12) Patent Application Publication
(10) Pub. No.: US 2023/0302801 A1
(43) Pub. Date: Sep. 28, 2023

(54) LIQUID DISCHARGE HEAD, LIQUID DISCHARGE UNIT, AND LIQUID DISCHARGE APPARATUS

(71) Applicant: Takahiro YOSHIDA, Kanagawa (JP)

(72) Inventor: Takahiro YOSHIDA, Kanagawa (JP)

(21) Appl. No.: 18/123,373

(22) Filed: Mar. 20, 2023

(30) Foreign Application Priority Data
Mar. 23, 2022 (JP) 2022-046770
Mar. 28, 2022 (JP) 2022-051456

(51) Int. Cl. B41J 2/14; B41J 2/145

(52) U.S. Cl. CPC B41J 2/1433; B41J 2/145

(57) ABSTRACT

A liquid discharge head includes: a nozzle plate having multiple nozzles arrayed at a predetermined pitch (d) corresponding to a recording resolution in a longitudinal direction of the nozzle plate. The multiple nozzles are divided into P number of sub-nozzle groups, each of the P number of sub-nozzle groups including the multiple nozzles as multiple sub-nozzles, where P is an integer of one or more, the multiple sub-nozzles are arrayed in the longitudinal direction at a first interval of (d×P), and each of the P number of sub-nozzle groups includes sub-nozzle rows each including the multiple sub-nozzles arrayed at the first interval of in the longitudinal direction and in a first inclination direction inclined relative to the longitudinal direction and a transverse direction orthogonal to the longitudinal direction.

### CROSS-REFERENCE TO RELATED APPLICATIONS

This patent application is based on and claims priority pursuant to 35 U.S.C. § 119(a) to Japanese Patent Application No. 2022-046770, filed on Mar. 23, 2022, and Japanese Patent Application No. 2022-051456, filed on Mar. 28, 2022, in the Japan Patent Office, the entire disclosure of which is hereby incorporated by reference herein.

### BACKGROUND

### Technical Field

The present embodiment relates to a liquid discharge head, a liquid discharge unit, and a liquid discharge apparatus.

### Related Art

A droplet discharge head is configured by connecting multiple head modules in which multiple nozzles for discharging a liquid is arranged. It is difficult to provide a large space between the connecting portion of the multiple head modules and the nozzle region where the nozzles are formed, and there is a problem that the robustness of the head is low.

The inkjet head may be configured by arranging multiple actuator units having an outer shape of a parallelogram. It is difficult to provide a large space between the connecting portion of the multiple actuator units and the nozzle region where the nozzles are formed in the actuator units, and there is a problem that the robustness of the head is low.

### SUMMARY

In an aspect of the present disclosure, a liquid discharge head includes: a nozzle plate having multiple nozzles arrayed at a predetermined pitch (d) corresponding to a recording resolution in a longitudinal direction of the nozzle plate. The multiple nozzles are divided into P number of sub-nozzle groups, each of the P number of sub-nozzle groups including the multiple nozzles as multiple sub-nozzles, where P is an integer of one or more, the multiple sub-nozzles are arrayed in the longitudinal direction at a first interval of (d×P), each of the P number of sub-nozzle groups includes sub-nozzle rows each including the multiple sub-nozzles arrayed at the first interval of (d×P) in the longitudinal direction and in a first inclination direction inclined relative to the longitudinal direction and a transverse direction orthogonal to the longitudinal direction, and a set of the sub-nozzle rows of the P number of the sub-nozzle groups arrayed in one row in the first inclination direction form a nozzle row the nozzle row has N number of the multiple sub-nozzles in a central region of the nozzle plate in the longitudinal direction, the nozzle row has M number of the multiple sub-nozzles less than the N number of the multiple sub-nozzles, the M number of the multiple sub-nozzles arrayed at a first end portion of the nozzle plate in the longitudinal direction, and the nozzle row having (N-M) number of the multiple sub-nozzles at a second end portion opposite to the first end portion of the nozzle plate across the central region in the longitudinal direction.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic configuration diagram illustrating an example of a liquid discharge apparatus;

FIG. 2 is a bottom view of an example of a head unit;

FIG. 3 is a schematic exploded view of an example of a head;

FIG. 4 is an explanatory plan view of a flow path portion of the head;

FIG. 5 is an enlarged cross-sectional perspective explanatory view of the flow path portion of the head;

FIG. 6 is an explanatory view of a definition of a nozzle row;

FIG. 7 is an explanatory view of the definition of the nozzle row;

FIG. 8 is a bottom view of a main part of a head module as a comparative example;

FIG. 9 is a bottom view of main parts of multiple head modules as a comparative example;

FIG. 10 is a bottom view of a main part of the head module according to a first embodiment of the present embodiment;

FIG. 11 is a bottom view of a main part of multiple head modules of the first embodiment;

FIG. 12 is a bottom view of a main part of a head according to a second embodiment of the present embodiment;

FIG. 13 is a bottom view of a main part of multiple head of the second embodiment;

FIG. 14 is a bottom view of a main part of a head according to a third embodiment of the present embodiment;

FIG. 15 is a bottom view of a main part of multiple head of the third embodiment;

FIG. 16 is a bottom view of a main part of a head according to a fourth embodiment of the present embodiment;

FIGS. 17A and 17B are schematic bottom views of a head in a fifth embodiment of the present embodiment;

FIG. 18 is a schematic bottom view of the head in the fifth embodiment of the present embodiment;

FIG. 19 is a schematic bottom view of heads, which illustrates a modification; and

FIG. 20 is a bottom view of a modification of the head unit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments for carrying out the disclosure will be described referring to the drawings. In the description of the drawings, the same elements are denoted by the same reference numerals, and redundant description is omitted.

[Outline of Liquid Discharge Apparatus]

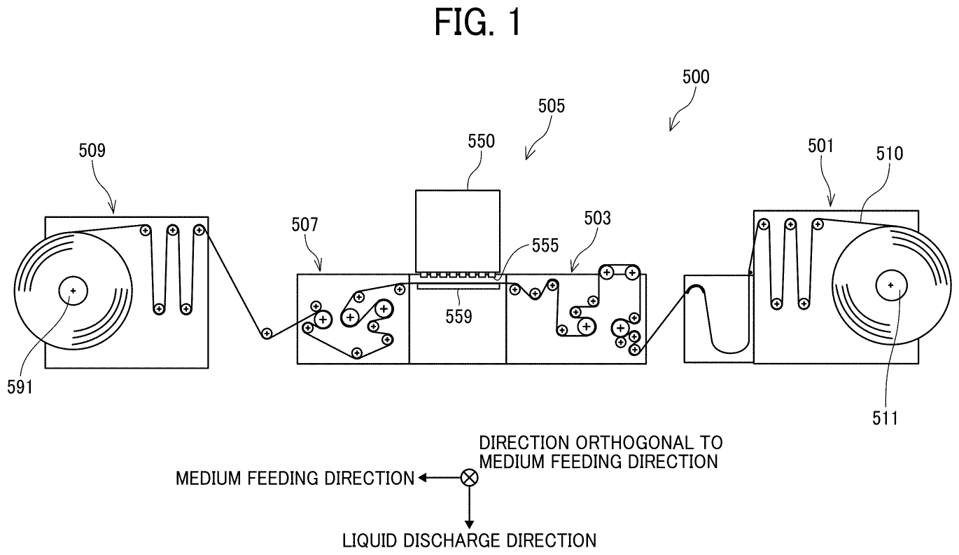

First, an outline of a liquid discharge apparatus is described below with reference to FIG. 1. FIG. 1 is a schematic configuration diagram illustrating an example of a liquid discharge apparatus. The liquid discharge apparatus exemplified herein is a printing apparatus 500 that discharges ink onto a sheet by an inkjet method to form an image on the sheet.

The printing apparatus 500 includes a sheet feeder 501, a conveyor 503, a printer 505, a dryer 507, and a sheet ejector 509. The sheet feeder 501 includes a holding roller 511 that holds a paper sheet 510 wound in a roll, and supplies the long continuous paper sheet 510 to the printer 505. The conveyor 503 performs tension control or meandering correction on the paper sheet 510 supplied from the sheet feeder 501, for example, adjusts the state of the tension and the conveyance position of the paper sheet 510, and conveys the paper sheet 510 to the printer 505.

The printer 505 includes an inkjet recording device 550 on which a head unit 555 is mounted, and a conveyance guide member 559 facing the inkjet recording device 550. The printer 505 forms an image on the paper sheet 510 by causing the head unit 555 to discharge ink onto the paper sheet 510 moving on the conveyance guide member 559. The head unit 555 is also referred to as a “liquid discharge unit”.

The number of head unit(s) 555 mounted on the inkjet recording device 550 may be appropriately increased or decreased according to the type and number of colors of ink used in the printing apparatus 500. The liquid used in the head unit 555 is not limited to ink, and may include a treatment liquid for modifying the surface of the paper sheet 510, a coating agent for protecting an image formed on the paper sheet 510, or the like.

The dryer 507 heats the paper sheet 510 on which the image is placed, and dries the paper sheet 510 and the image formed on the paper sheet 510. The sheet ejector 509 includes a winding roller 591 that winds the paper sheet 510, and winds the paper sheet 510 fed from the dryer 507.

Hereinafter, a configuration of the printing apparatus 500 will be described, but the liquid discharge apparatus according to the present embodiment is not limited to the printing apparatus. For example, the present invention can also be applied to a solid shaping apparatus (three-dimensional shaping apparatus) that discharges a shaping liquid to a powder layer obtained by forming powder into a layer in order to shape a solid object (three-dimensional object). In addition, the present invention can also be applied to an electronic element production apparatus that discharges a resist pattern forming liquid to form a resist pattern of an electronic circuit.

The medium is not limited to the paper sheet 510. In addition to paper, various materials are applicable such as fiber, cloth, leather, metal, plastic, glass, wood, and ceramics. The form of the medium is not limited to a long sheet, and may be a medium cut into a predetermined size in advance.

The printing apparatus 500 herein has a line-type configuration in which the paper sheet 510 is moved with respect to the inkjet recording device 550 at a fixed position and an image is formed on the paper sheet 510, but is not limited to the line type. The inkjet recording device 550 and the paper sheet 510 are moved relative to each other. Therefore, the printing apparatus 500 may have a serial type configuration in which the inkjet recording device is moved in a direction orthogonal to the paper feeding direction with respect to the intermittently fed paper sheet to form an image on the paper sheet 510, for example. Alternatively, the printing apparatus 500 may have a flatbed-type configuration in which the inkjet recording device is moved in the XY direction with respect to the paper sheet held on the sheet placement table to form an image on the paper sheet 510.

Examples of discharge material used in the apparatus discharging a liquid include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as deoxyribonucleic acid (DNA), amino acid, protein, or calcium, or an edible material, such as a natural colorant. The liquid may contain fine powder such as metal powder. These liquids can be used for inkjet ink, coating material, surface treatment liquid, constituent elements of electronic elements and light emitting elements, liquid for forming electronic circuit resist patterns, material liquid for three dimensional modeling, and the like, for example,

[Configuration of Head Unit]

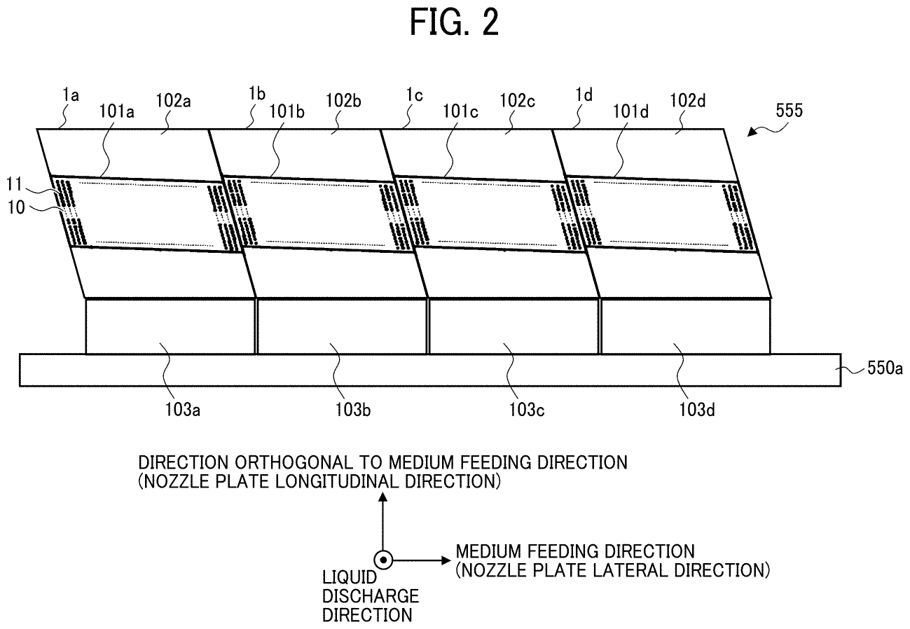

Next, a configuration of the head unit will be described with reference to FIG. 2. FIG. 2 is a bottom view of an example of the head unit, which illustrates one of eight head units 555 in the inkjet recording device 550 illustrated in FIG. 1 as viewed from the conveyance guide member 559 side.

The head unit 555 includes multiple head modules 1a, 1b, 1c, and 1d arranged in a direction orthogonal to the medium feeding direction. Hereinafter, these head modules 1a to 1d will be collectively referred to as “head module 1”. The head modules 1a to 1d further include heads 101a to 101d, head holding members 102a to 102d, and mount members 103a to 103d. Hereinafter, the heads 101a to 101d will be collectively referred to as “head 101”, the head holding members 102a to 102d will be collectively referred to as “head holding member 102”, and the mount members 103a to 103d will be collectively referred to as “mount member 103”. The head 101 includes a nozzle plate 10 having an outer shape of a substantially parallelogram in which multiple nozzles is formed, and the head 101 is held by the head holding member 102. The head holding member 102 partially includes a mount member 103. The mount member 103 is attached to a support member 550a provided in the inkjet recording device 550 so that the head unit 555 is fixed to the inkjet recording device 550. The head unit 555 here is an example of a “liquid discharge unit”, and the head 101 is an example of a “liquid discharge head”.

[Configuration of Head]

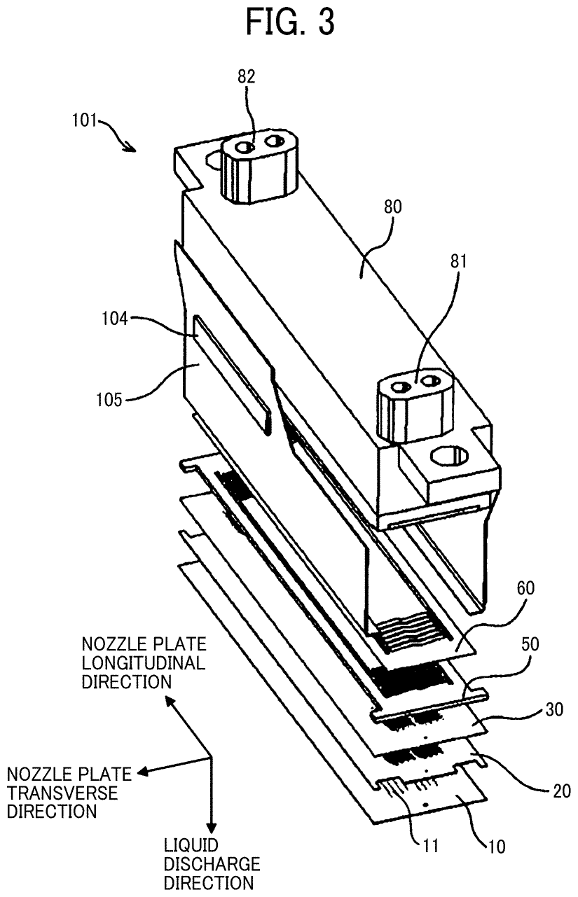

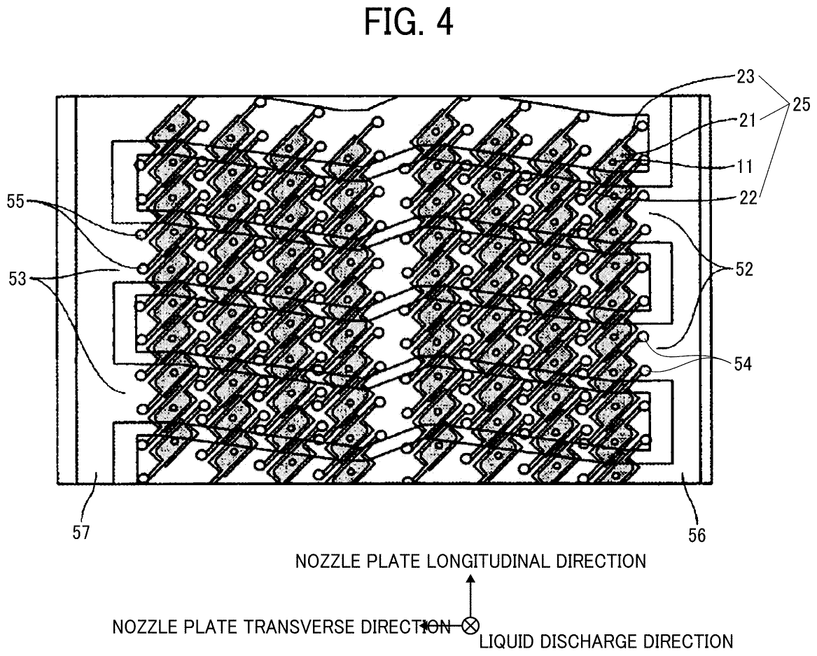

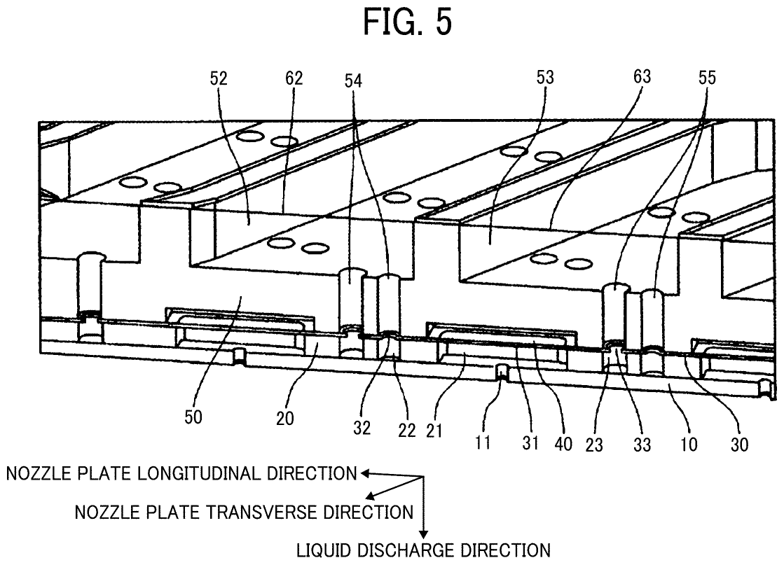

Next, a configuration of the head will be described with reference to FIGS. 3 to 5. FIG. 3 is a schematic exploded view of an example of the head, which illustrates only the head 101 forming the head module 1 of FIG. 2. FIG. 4 is a plan explanatory view of a flow path portion of the head, and FIG. 5 is an enlarged cross-sectional perspective explanatory view of the flow path portion of the head. The nozzle plate 10 has an outer shape of a substantially parallelogram as illustrated in FIG. 2. However, the following description is made with reference to a drawing simplified to a rectangle.

The head 101 includes a nozzle plate 10, a channel plate (individual channel member 20), a diaphragm member 30, a common channel member 50, a damper 60, a frame member 80, a substrate (flexible wiring substrate) 105 on which a drive circuit 104 is mounted, and the like.

The nozzle plate 10 includes multiple nozzles 11 that discharges a liquid (ink in the present embodiment), and the multiple nozzles 11 is arranged side by side in a two-dimensional manner.

The individual channel member 20 (channel plate) includes multiple pressure chambers 21 (individual chambers) respectively communicating with the multiple nozzles 11, multiple individual supply channels 22 respectively communicating with the multiple pressure chambers 21, and multiple individual collection channels 23 respectively communicating with the multiple pressure chambers 21. The single pressure chamber 21, the individual supply channels 22 communicating therewith, and the individual collection channels 23 will be collectively referred to as individual channels 25.

The diaphragm member 30 forms a diaphragm 31 which is a deformable wall surface of the pressure chamber 21, and a piezoelectric element 40 is integrally provided on the diaphragm 31. Further, the diaphragm member 30 includes a supply-side opening 32 that communicates with the individual supply channel 22 and a collection-side opening 33 that communicates with the individual collection channel 23.

The piezoelectric element 40 is a pressure generator to deform the diaphragm 31 to pressurize the liquid in the pressure chamber 21.

The individual channel member 20 and the diaphragm member 30 are not limited to being separate members. For example, the individual channel member 20 and the diaphragm member 30 can be integrally formed of the same member using a silicon on insulator (SOI) substrate. That is, using an SOT substrate on which a silicon oxide film, a silicon layer, and a silicon oxide film are formed in this order, the silicon substrate can be used as the individual channel member 20, and the diaphragm 31 can be formed of the silicon oxide film, the silicon layer, and the silicon oxide film. In this configuration, the layer configuration of the silicon oxide film, the silicon layer, and the silicon oxide film of the SOI substrate serves as the diaphragm member 30. Thus, the diaphragm member 30 may be formed by materials formed as films on a surface of the individual channel member 20.

The common channel member 50 includes multiple common-supply branch channels 52 that communicates with two or more individual supply channels 22 and multiple common-collection branch channels 53 that communicates with two or more individual collection channels 23. The multiple common-supply branch channels 52 and the multiple common-collection branch channels 53 are arranged alternately adjacent to each other in a direction orthogonal to the medium feeding direction. The common channel member 50 includes a through hole serving as a supply port 54 that connects the supply-side opening 32 of the individual supply channel 22 and the common-supply branch channels 52, and a through hole serving as a collection port 55 that connects the collection-side opening 33 of the individual collection channel 23 and the common-collection branch channels 53. The common channel member 50 forms one or more common-supply main channels 56 communicating with the multiple common-supply branch channels 52 and one or more common-collection main channels 57 communicating with the multiple common-collection branch channels 53.

The damper 60 includes a supply-side damper 62 facing the supply ports 54 of the common-supply branch channels 52 and a collection-side damper 63 facing (facing) the collection ports 55 of the common-collection branch channels 53. The common-supply branch channels 52 and the common-collection branch channels 53 are configured by sealing groove portions alternately arranged in the common channel member 50, which is the same member, with the supply-side damper 62 or collection-side damper 63 of the damper 60. As the damper material of the damper 60, a metal thin film or an inorganic thin film resistant to an organic solvent is preferably used. The thickness of the supply-side damper 62 and collection-side damper 63 of the damper 60 is preferably 10 μm or less.

A protective film (also referred to as wetted film) is formed on the inner wall surfaces of the common-supply branch channels 52 and common-collection branch channels 53 and the inner wall surfaces of the common-supply main channel 56 and common-collection main channel 57, in order to protect the inner wall surfaces against the liquid flowing in the channels. For example, a silicon oxide film is formed on the inner wall surfaces of the common-supply branch channel 52 and common-collection branch channel 53 and the inner wall surfaces of the common-supply main channel 56 and common-collection main channel 57 by heat treating the Si substrate. A tantalum silicon oxide film from the ink is formed on the silicon oxide film to protect the surface of the Si substrate.

The frame member 80 includes a supply port 81 and a discharge port 82 on the top. The supply port 81 supplies a liquid to the common-supply main channel 56, and the discharge port 82 discharges the liquid from the common-collection main channel 57.

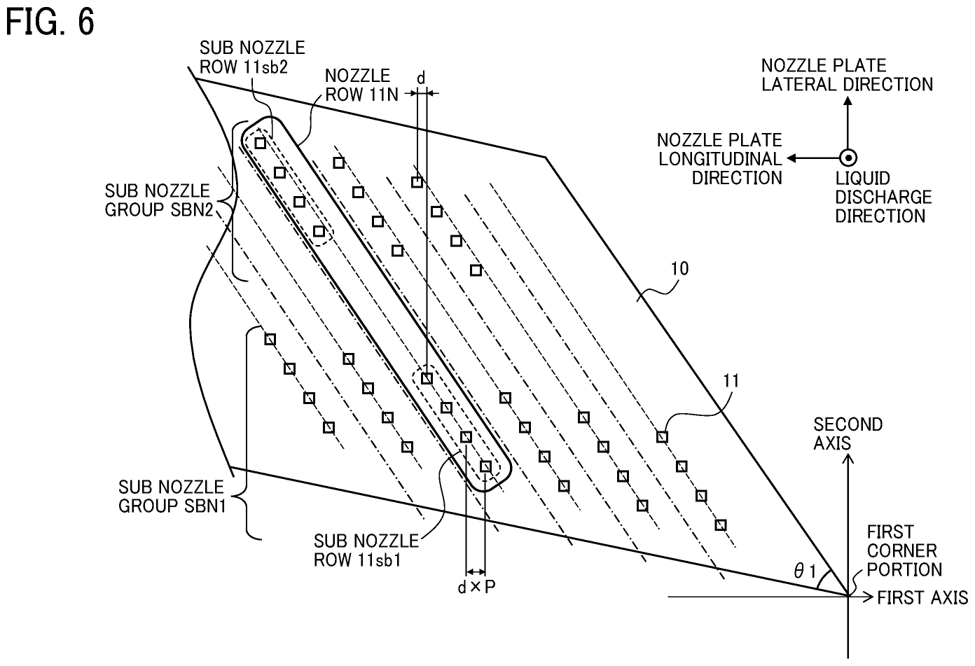

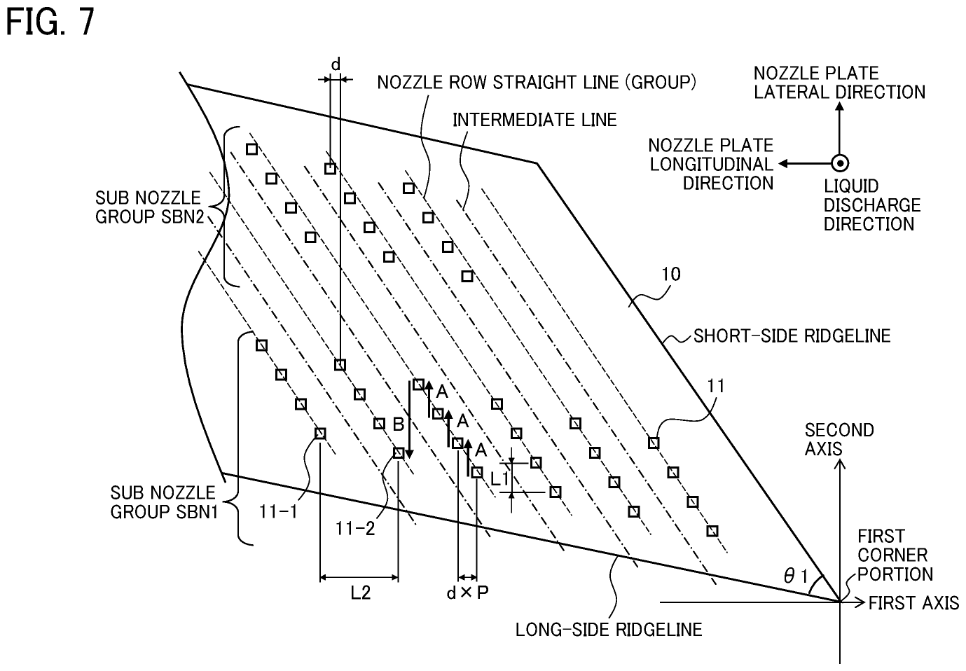

Next, in describing the arrangement of the nozzles 11 provided on the nozzle plate 10, the definition of the “nozzle row” in the present embodiment will be described with reference to FIGS. 6 and 7. In FIGS. 6 and 7, the nozzles 11 are expressed in a square, but the nozzle 11 may have a circular shape or another shape. The size and diameter of the nozzles 11 may be smaller than the size and diameter illustrated in the drawings.

As illustrated in FIG. 6, the multiple nozzles 11 provided on the nozzle plate 10 constitute sub-nozzle rows 11sb1 and 11sh2 by the multiple nozzles 11 (four nozzles in the example of the drawing) arranged at a spacing of d P in a longitudinal direction of the nozzle plate 10. As for the above spacing, d represents the recording resolution, P represents the number of sub-nozzle groups to be described later, and P is an integer of 1 or more.

In each sub-nozzle row, multiple sub-nozzle rows 11sb1 constitutes a sub-nozzle group SBN1, and multiple sub-nozzle rows 11sb2 constitutes a sub-nozzle group SBN2. That is, the drawing illustrates a configuration in which the two sub-nozzle groups SBN1 and SBN2 are provided on the nozzle plate 10 that is, P=2.

The sub-nozzle groups SBN1 and SBN2 have sub-nozzle rows 11sb1 and 11sb2 including multiple sub-nozzles arranged at a spacing of d×P in the longitudinal direction and in a direction inclined with respect to the longitudinal direction and the nozzle plate transverse direction. The “sub-nozzles” mean multiple nozzles in each sub-nozzle group, among all the nozzles 11 provided on the nozzle plate 10. That is, the multiple nozzles 11 belonging to the sub-nozzle group SBN1 is sub-nozzles forming the sub-nozzle group SBN1. The multiple nozzles 11 belonging to the sub-nozzle group SBN2 is sub-nozzles forming the sub-nozzle group SBN2. A set of rows including the sub-nozzle rows 11sb1 and 11sb2 of the P (two in the example of the drawing) sub-nozzle groups SBN1 and SBN2 arranged in one line along the inclined direction is defined as “nozzle row” (nozzle row 11N).

The number of nozzles 11 forming the sub-nozzle rows 11sb1 and 11sb2 is not limited to tour. The number of nozzles 11 forming the sub-nozzle rows 11sb1 and 11sb2 may be more than four or less than four. The number of the sub-nozzle groups SBN1 and SBN2 is not limited to two. The number of the sub-nozzle groups SBN1 and SBN2 may be more than two or may be one.

FIG. 7 is an explanatory view more specifically describing the definition of the nozzle row. As described above, the multiple nozzles 11 is divided into P (P is an integer of 1 or more) sub-nozzle groups SBN1 and SBN2 in the nozzle plate transverse direction. The multiple nozzles 11 included in each of the sub-nozzle rows 11sb1 and 11sb2 (see FIG. 6) of the sub-nozzle groups SBN1 and SBN2 is arranged at the spacing of d×P in the longitudinal direction.

The arrangement of the multiple nozzles 11 in the longitudinal direction in the nozzle plate transverse direction is sequentially shifted by a predetermined distance L1 in a first direction (arrow A direction of in FIG. 7) in the nozzle plate transverse direction in correspondence with a predetermined number of nozzles. The nozzles of the next sub-nozzle row are shifted in a second direction (arrow B direction in FIG. 7) opposite to the first direction. The arrangement of the nozzle 11 has a rule of repeating the above shifts.

The nozzle plate 10 has a longitudinal ridgeline (a long side of the ridgeline) extending in the longitudinal direction and a lateral ridgeline (a short side of the ridgeline) extending in the nozzle plate transverse direction. Herein, assuming that the longitudinal ridgeline and the lateral ridgeline intersect at a first corner at an angle θ1 (θ1 is an acute angle), a first axis extending in the longitudinal direction and a second axis extending in the transverse direction will be defined as two orthogonal axes for forming a coordinate plane such that a quadrant in which the lateral ridgeline extends from the first corner as an origin is a second quadrant.

Among the sub-nozzle groups, a sub-nozzle group closest to the first corner in the transverse direction will be defined as a first sub-nozzle group (sub-nozzle group SBN1 in this example). A row of multiple nozzles including one of the multiple nozzles 11 included in the sub-nozzle group SBN1 and one or more of nozzles arranged at equal spacings of d×P on the first axis negative side and at equal spacings of the predetermined distance L1 on the second axis positive side as viewed from the one nozzle will be defined as “first sub-nozzle row”. A sub-nozzle group arranged adjacent to the first sub-nozzle group in the transverse direction will be set as a second sub-nozzle group (sub-nozzle group SBN2 in this example), and a sub-nozzle row included in the second sub-nozzle group (sub-nozzle group SBN2 in this example) will be defined as “second sub-nozzle row”. When the P number of sub-nozzle groups is three or more, a third sub-nozzle row and a fourth sub-nozzle row will be similarly defined.

The number obtained by dividing the spacing between the nozzles arranged closest to the second axis negative side included in the multiple first sub-nozzle rows in the region near the center of the nozzle plate 10 by a predetermined pitch (d) will be defined as N.

With a nozzle arranged closest to the second axis negative side included in the first sub-nozzle row (the nozzle 11-1 in this example) a base point, a distance by which the base point is shifted on one straight line passing through the multiple nozzles included in the first sub-nozzle row so as to coincide with a nozzle arranged closest to the second axis negative side included in the sub-nozzle row adjacent to the first sub-nozzle row (the nozzle 11-2 in this example) will be defined as L2.

A straight line group (broken straight lines in FIG. 7) including the straight line passing through the multiple nozzles included in the first sub-nozzle row and multiple straight lines equally shifted by the distance L2 will be defined as “nozzle row straight line group”, and lines passing through the middle of the straight lines included in the nozzle row straight line group (one-dot chain straight lines in FIG. 7) will be defined as “intermediate lines”.

In this case, the “nozzle row” will be defined as a row including, among the multiple nozzles 11 included in the entire P sub-nozzle groups, nozzles located on one straight line included in the nozzle row straight line group, nozzles located on an intermediate line adjacent to the first axis positive side in the longitudinal direction as viewed from the one straight line or located closer to the one straight line than the intermediate line, and nozzles located closer to the one straight line than the intermediate line adjacent to the first axis negative side as viewed from the one straight line.

### Comparative Example

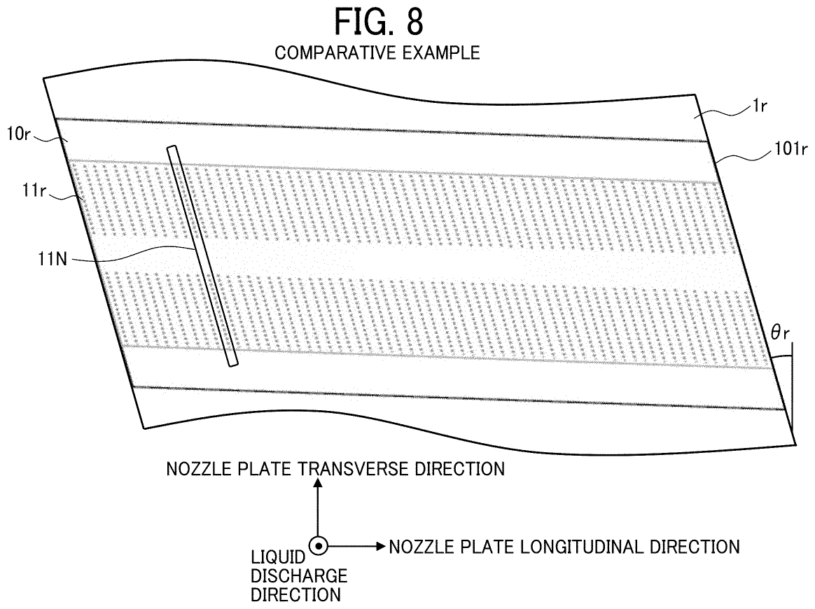

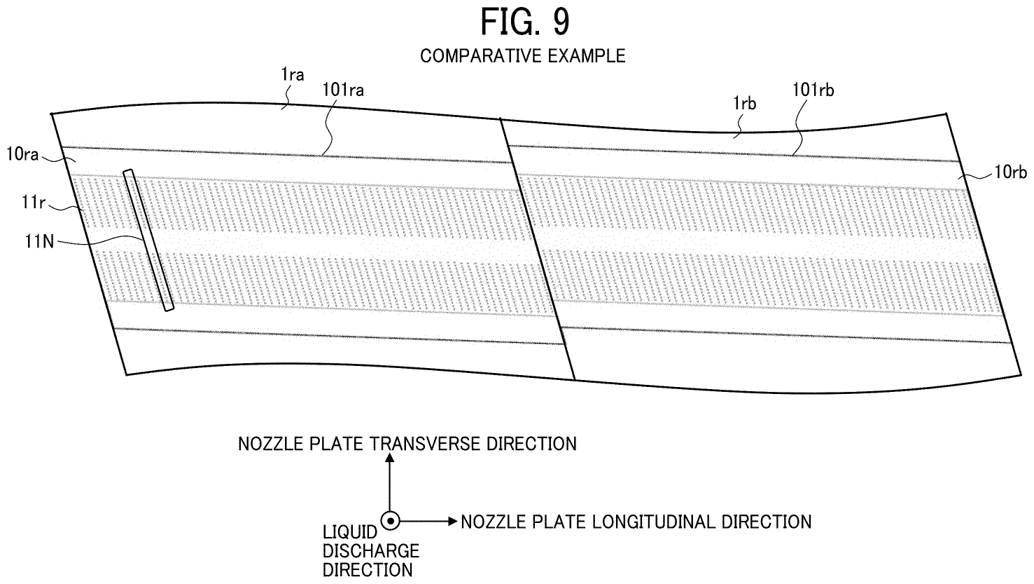

Next, a configuration of a comparative example will be described with reference to FIGS. 8 and 9. FIG. 8 is a bottom view of a main part of a head module as a comparative example, and FIG. 9 is a bottom view of a main part of multiple head modules as the comparative examples.

The head module IR illustrated as the comparative example has a ridgeline inclined at an angle θr with respect to the medium feeding direction, and a head 101r and a nozzle plate 10r are also formed in shapes along the ridgeline. The head 101r has the nozzle plate 10r in an outer shape of a parallelogram, and multiple nozzles 11r is regularly arranged two-dimensionally on the nozzle plate 10r. The arrangement of the nozzles 11r is an arrangement in which one nozzle row 11N is formed by N nozzles 11r, and multiple nozzle rows 11N is provided in parallel to the above-described ridgeline and in a direction orthogonal to the medium feeding direction.

In the head module 1r of the above configuration, multiple head modules 1ra and 1rb can be arranged in one row in the direction orthogonal to the medium feeding direction as illustrated in FIG. 9. However, in the comparative example, the nozzle row 11N uniformly includes N nozzles 11r. Therefore, in order to arrange the head modules it so that the spacings in the side-to-side direction (direction orthogonal to the medium feeding direction) between the nozzle rows 11N are equal while connecting the N nozzles 11r included in the multiple head modules 1ra and 1rb so as to be arranged at a predetermined pitch d (recording resolution), it is desired to bring the multiple head modules 1ra and 1rb close to each other in the side-to-side direction. Therefore, it is difficult to take a sufficient spacing between the two head modules.

That is, it is desired to arrange the nozzle row located at the left end of the head module 1rb next to the nozzle row located at the right end of the head module 1ra, and a sufficient spacing may not be secured between the two nozzle rows. Therefore, there is a problem that the distance from the nozzle row at the end portion to the ridgeline of the head 101r is short, so that the nozzles, and the pressure chambers and flow paths connected to the nozzles are easily damaged by an impact from the outside or the like.

Hereinafter, a configuration of the head module according to an embodiment of the present embodiments will be described.

### First Embodiment

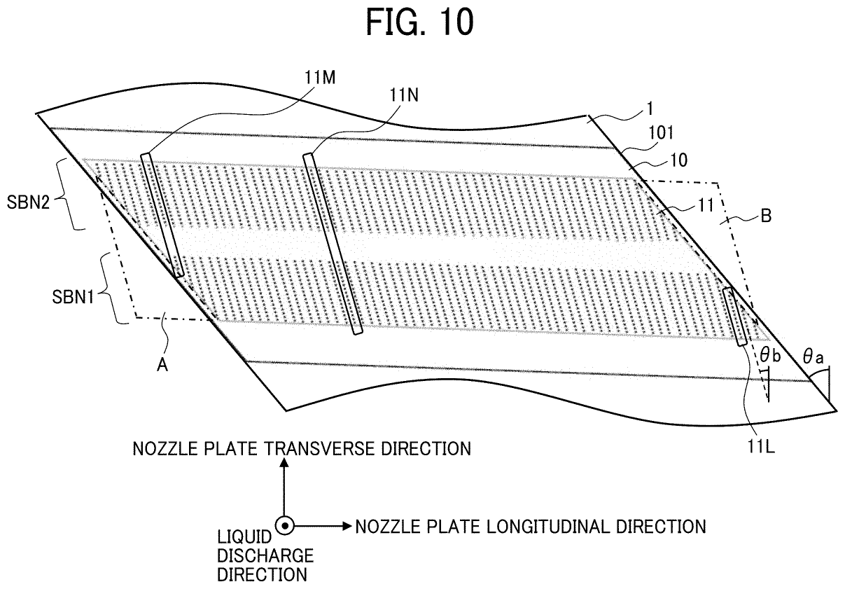

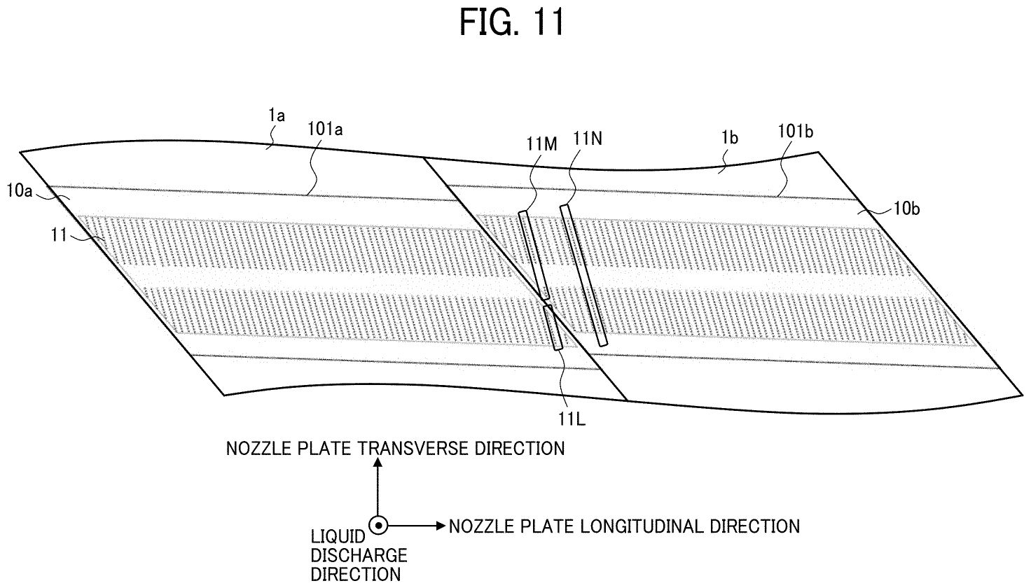

A configuration of a first embodiment will be described with reference to FIGS. 10 and 11. FIG. 10 is a bottom view of a main part of the head module according to the first embodiment, and FIG. 11 is a bottom view of a main part of multiple head modules in the first embodiment.

The head module 1 illustrated as the first embodiment has a ridgeline inclined at an angle θa with respect to the nozzle plate transverse direction. The head 101 provided in the head module 1 and the nozzle plate 10 provided in the head 101 are also shaped along the ridgeline. The head 101 includes the nozzle plate 10 having an outer shape of a substantially parallelogram, and the multiple nozzles 11 is regularly arranged two-dimensionally on the nozzle plate 10.

The nozzles 11 is arranged such that N nozzles 11 form one nozzle row 11N, and the multiple nozzle rows 11N is provided in the longitudinal direction with an inclination of an angle θb(≠θa) with respect to the nozzle plate transverse direction. Thai is, the arrangement direction of the nozzles 11 forming the nozzle rows 11N is different from the direction of the ridgeline of the nozzle plate 10.

As a result, in the arrangement of the nozzles 11 on the nozzle plate 10, the nozzle rows 11N having N nozzles 11 in one row are arranged near the center in the direction in which the multiple nozzle rows is arranged (longitudinal direction). On the other hand, the nozzle rows 11M having M N) nozzles 11 in one row are arranged at one end portion of the nozzle plate 10, and a nozzle row 11L having N-M nozzles 11 in one row is arranged at the other end portion.

In the present embodiment, the nozzle rows 11N are divided into the first sub-nozzle group SBN1 and the second sub-nozzle group SBN2 spaced from the first sub-nozzle group SBN1 in the nozzle plate transverse direction. Providing the multiple sub-nozzle groups makes it possible to increase the recording resolution of the head 101 while securing a physical distance between the nozzles (distance between the nozzles 11 on the surface of the nozzle plate 10) as compared with a case where there is only one sub-nozzle group.

The head may be configured such that the first sub-nozzle group SBN1 and the second sub-nozzle group SBN2 discharge liquids of different colors. The spacing between the nozzles 11 arranged in the region of the right end portion and/or the left end portion of the nozzle plate 10 in the longitudinal direction may be different from the spacing between the nozzles 11 arranged in the central region as long as the spacing does not substantially affect the image recorded on the medium.

The number of nozzles 11 included in the first sub-nozzle group SBN1 sequentially decreases from the central region toward one end (left end in FIG. 10) of the nozzle plate 10. The nozzles 11 are arranged such that the number of the nozzles 11 included in the second sub-nozzle group SBN2 sequentially decreases after the number of the nozzles 11 included in the first sub-nozzle group SBN1 becomes zero.

At the other end (the right end in FIG. 10) of the nozzle plate 10, the number of the nozzles 11 included in the second sub-nozzle group SBN2 sequentially decreases from the central region toward the other end of the nozzle plate 10. The nozzles 11 are arranged such that the number of the nozzles 11 included in the first sub-nozzle group SBN1 sequentially decreases after the number of the nozzles 11 included in the second sub-nozzle group SBN2 becomes zero. One end portion (left end portion in FIG. 10) of the nozzle plate 10 is an example of a “first end portion”, and the other end portion (right end portion in FIG. 10) of the nozzle plate 10 is an example of a “second end portion”.

In the head module 1 having the above configuration, as illustrated in FIG. 11, the multiple head modules 1a and 1b can be arranged in one row in the longitudinal direction. At this time, the nozzle row 11M including the M nozzles 11 of the head module 1b and the nozzle row 11L including the N-M nozzles 11 of the head module 1a are aligned at a spacing in the vertical direction (nozzle plate transverse direction). As a result, a nozzle row including N nozzles 1, which is equivalent to the nozzle row 11N, is formed. When the nozzle row 11M of the head module 1b and the nozzle row 11L of the head module 1a are arranged in the vertical direction (nozzle plate transverse direction), the head modules can be connected to each other with a predetermined gap in the vertical direction between the nozzles at the end portions of both the head modules.

Thus, the head modules can be connected to each other such that the nozzles 11 included in the multiple head modules 1a and 1b are arranged at the predetermined pitch d (recording resolution) without arranging the nozzles 11 to almost the end of the head module 1 and without greatly offsetting the entire head module in the vertical direction with respect to the other head module. Accordingly, a linear head having an arbitrary length can be manufactured by arranging the head modules 1 in one row in the longitudinal direction.

In addition, since the spacing in the vertical direction can be secured between the head modules and the distance from the nozzle 11 at the end to the ridgeline of the head 101 can be increased, the head 101 itself becomes strong and achieves enhancement in robustness. As a result, even if the side surface of the nozzle plate 10 of the head 101 receives an impact from the outside, the impact is less likely to be transmitted from the ridgeline of the side surface to the nozzle, the pressure chamber, the flow path, and the like, and the head 101 can be prevented from being damaged.

In the present embodiment, missing regions A and B illustrated in FIG. 10 can be postulated. That is, N nozzles are arranged in each row at both ends of the nozzle plate 10 on the same rule as that for the region near the center. A region outside the short side of the ridgeline of the nozzle plate 10 at the first end (the left end in FIG. 10) of the nozzle plate 10 will be defined as first chipped region A. A region outside the short side of the ridgeline of the nozzle plate 10 at the second end (the right end in FIG. 10) of the nozzle plate 10 will be defined as second chipped region B.

When defined as described above, in the present embodiment, at least some of the N-M nozzles among the N nozzles assumed at the first end are in the first chipped region A. In addition, at least some of the M nozzles among the N nozzles assumed at the second end are in the second chipped region B.

Connecting the head modules 1 having such a nozzle arrangement as illustrated in FIG. 9 allows the nozzle rows to be regularly arranged without increasing the head size.

As described above, in the present embodiment, the nozzle plate 10 is provided on which the multiple nozzles 11 discharging a liquid is arranged at the predetermined pitch (d) corresponding to the recording resolution in the longitudinal direction. The multiple nozzles 11 is divided into P (P is an integer of 1 or more) sub-nozzle groups SBN1 and SBN2 including multiple sub-nozzles arranged at a spacing of (d×P) in the longitudinal direction. The sub-nozzle groups SBN1 and SBN2 have the sub-nozzle rows 11sb1 and 11sb2, respectively, including multiple sub-nozzles that is arranged at the spacing of (d×P) left in the longitudinal direction, in the longitudinal direction and the direction inclined at the angle θb with respect to the nozzle plate transverse direction orthogonal to the longitudinal direction. Assuming that a set of rows including the sub-nozzle rows 11sb1 and 11sb2 of the P sub-nozzle groups SBN1 and SBN2, which are arranged in one line along the inclined direction, is defined as nozzle row 11N, the nozzle row 11N having N nozzles is arranged in a region near the center of the nozzle plate 10 in the longitudinal direction, the nozzle row 11M having M nozzles, which is less than N nozzles, is arranged at the first end portion (left end portion in FIG. 10) of the nozzle plate 10 Which is closer to the first end portion than the region near the center in the longitudinal direction, and the nozzle row 11L having (N-M) nozzles is arranged at the second end portion (right end portion in FIG. 10) of the nozzle plate 10 which is closer to the second end portion opposite to the first end portion than the region near the center in the longitudinal direction.

Accordingly, the distance from the nozzle 11 at the end portion to the ridgeline of the head 101 can be increased, and the robustness of the head 101 can be enhanced. As a result, even if the head 101 receives an impact from the outside, the impact is less likely to be transmitted to the nozzles, the pressure chamber, the flow paths, and the like, so that damage to the head 101 can be prevented.

As described above, the direction in which the nozzle rows 11N, 11M, and 11L are aligned (inclined at the angle θb with respect to the nozzle plate transverse direction) is different from the direction of the ridgeline, of the short side of the nozzle plate (at the angle θa with respect to the nozzle plate transverse direction).

Accordingly, when the multiple nozzle plates 10 is arranged in the longitudinal direction, the short sides of the ridgelines of the nozzle plates 10 are arranged so as to cross between the M nozzles and the N-M nozzles. In this case, the M nozzles of one nozzle plate 10 and the N-M nozzles of the other nozzle plate can be regularly arranged without greatly offsetting the two nozzle plates 10 in the nozzle plate transverse direction. Further, arranging the two nozzle plates 10 such that the short sides of the ridgelines thereof face each other reduces the size of the entire head in the transverse direction. The distances from the nozzles at the end portions of the M nozzles to the short sides of the ridgelines and the distances from the nozzles at the end portions of the N nozzles to the short sides of the ridgelines can be secured in the nozzle plate transverse direction, and the nozzles at the end portions can be further prevented from being broken due to an external impact or the like.

As described above, the multiple nozzle rows 11N, 11M, and 11L, is arranged in a region whose outer shape is a substantially parallelogram.

As a result, the multiple nozzle plates 10 can be regularly arranged to form a long head, and the size of the entire head can be reduced. Furthermore, the overall size of the head unit formed by arranging the multiple heads can be reduced.

As described above, the value of P is an integer of 2 or more, and the multiple sub-nozzle groups includes the first sub-nozzle group SBN1 and the second sub-nozzle group SBN2, and the nozzles 11 are arranged such that the number of nozzles 11 included in the sub-nozzle row 11sb1 of the first sub-nozzle group SBN1 sequentially decreases from the region near the center toward the first end (the left end in FIG. 10), and after the number of nozzles 11 included in the sub-nozzle row 11sb1 of the first sub-nozzle group SBN1 becomes zero, the number of nozzles 11 included in the sub-nozzle row 11sb2 of the second sub-nozzle group SBN2 sequentially decreases.

The value of P is an integer of 2 or more, the multiple sub-nozzle groups includes the first sub-nozzle group SBN1 and the second sub-nozzle group SBN2, and the nozzles 11 are arranged such that the number of nozzles 11 included in the sub-nozzle row 11sb2 of the second sub-nozzle group SBN2 sequentially decreases from the region near the center toward the second end (the right end in FIG. 10), and after the number of nozzles 11 included in the sub-nozzle row 11sb2 of the second sub-nozzle group SBN2 becomes zero, the number of nozzles 11 included in the sub-nozzle row 11sb1 of the first sub-nozzle group SBN1 sequentially decreases.

As a result, the recording resolution of the head can be increased as compared with a case where there is only one sub-nozzle group, and the nozzle row including the same number of nozzles as the nozzles in the region near the center can be formed without arranging the nozzles 11 up to almost the end of the head (nozzle plate).

In addition, assuming that N nozzles are arranged per row at each of the first end and the second end on the same rule as that in the region near the center, that a region outside the short side of the ridgeline of the nozzle plate 10 at the first end is defined as first chipped region A, and that a region outside the short side of the ridgeline of the nozzle plate 10 at the second end is defined as second chipped region B, at least some of the N-M nozzles among the N nozzles assumed at the first end are in the first chipped region A, and at least some of the M nozzles among the N nozzles assumed at the second end are in the second chipped region B.

This makes it possible to form a nozzle row including the same number of nozzles as those in the region near the center without arranging the nozzles up to almost the end of the head (nozzle plate).

### Second Embodiment

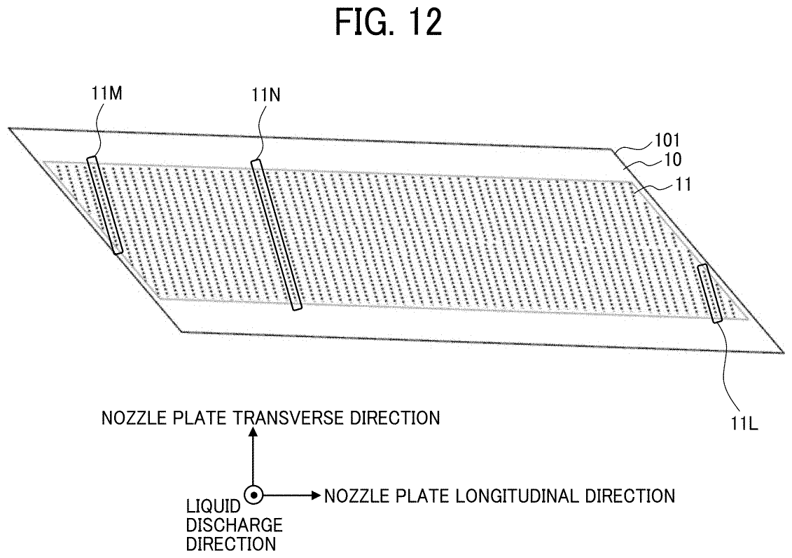

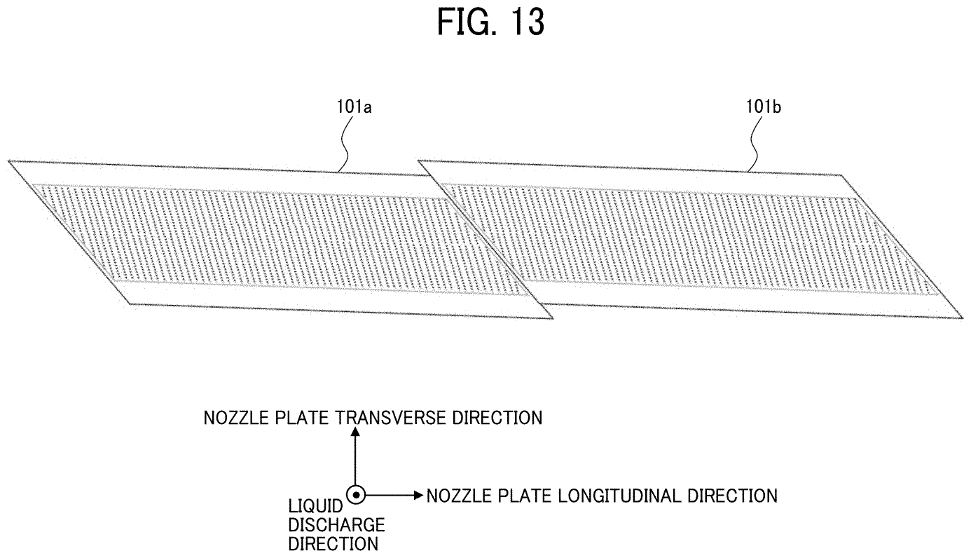

Next, a configuration of a second embodiment will be described with reference to FIGS. 12 and 13. In the subsequent embodiments, illustration of a head module 1 is omitted, and only a head 101 (nozzle plate 10) will be described in a simplified manner. FIG. 12 is a bottom view of a main part of the head according to the second embodiment, and FIG. 13 is a bottom view of a main part of multiple heads according to the second embodiment.

Although the head 101 in the first embodiment has the nozzle rows 11N divided into the first sub-nozzle group SBN1 and the second sub-nozzle group SBN2, a nozzle row 11N in the second embodiment may not be divided as illustrated in FIG. 12. In this case, nozzles 11 forming the nozzle rows 11N, 11M, and 11L are arranged side by side at equal spacings in each of the nozzle rows 11N, 11M, and 11L.

In the case of the second embodiment, as in the first embodiment, multiple heads 101a and 101b can be arranged in one row in a longitudinal direction as illustrated in FIG. 11, and the same advantageous effects as those of the first embodiment can be obtained.

### Third Embodiment

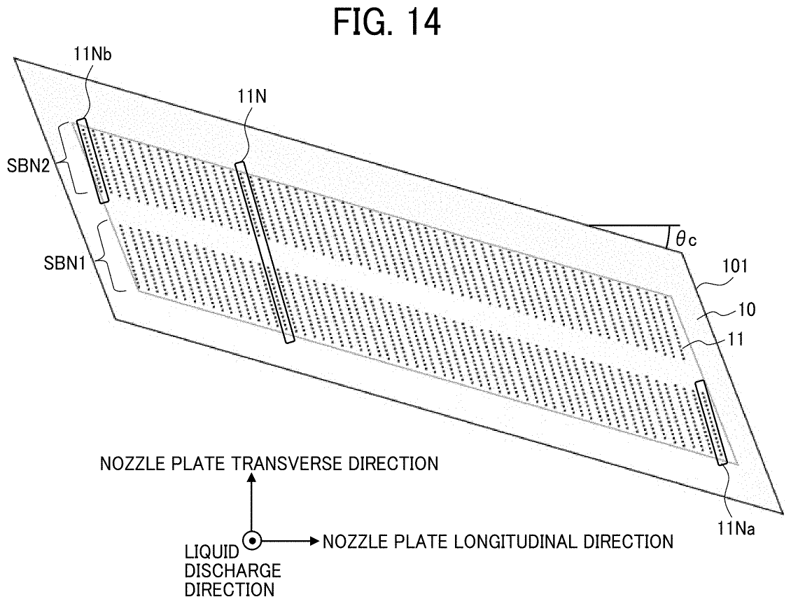

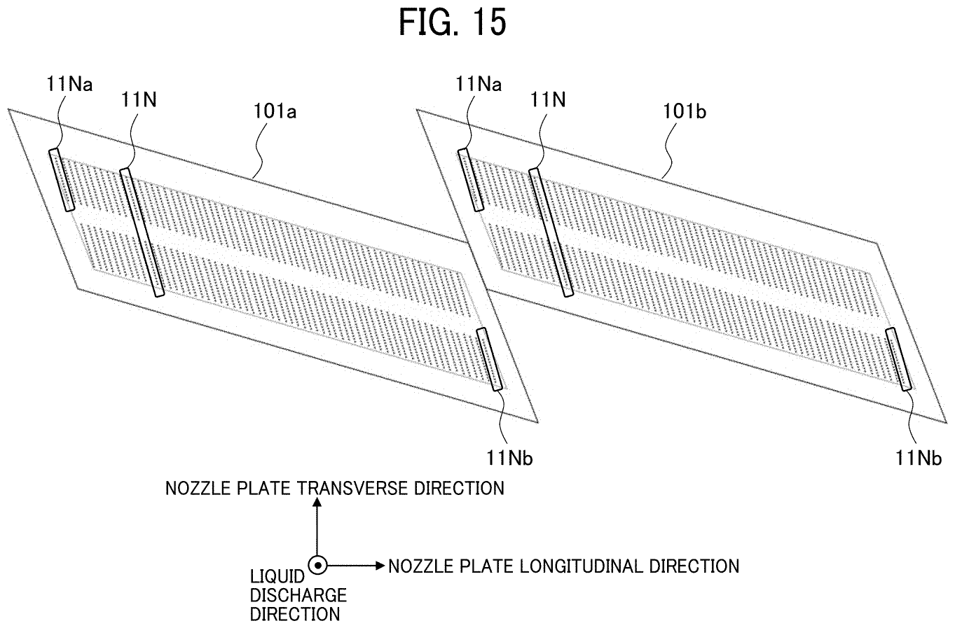

Next, a configuration of a third embodiment will be described with reference to FIGS. 14 and 15. FIG. 14 is a bottom view of a main part of a head according to the third embodiment, and FIG. 15 is a bottom view of a main part of multiple heads according to the third embodiment.

A head 101 illustrated as the third embodiment has a larger inclination (angle θc) formed with respect to the longitudinal direction than in the first embodiment and the second embodiment. The head 101 includes a nozzle plate 10 having an outer shape of a substantially parallelogram, and multiple nozzles 11 is regularly arranged in a two-dimensional array on a nozzle plate 10. The nozzles 11 are arranged such that N nozzles 11 form one nozzle row 11N, and multiple nozzle rows 11N is provided in the longitudinal direction.

In the arrangement direction of the multiple nozzle rows (longitudinal direction), nozzle rows 11N having N nozzles 11 are arranged in a region near the center, and nozzle rows 11Na and 11Nb having N/2 nozzles 11 are arranged at both ends. The nozzle rows 11N are divided into a first sub-nozzle group SBN1 and a second sub-nozzle group SBN2 in a direction intersecting the arrangement direction of the nozzle rows (nozzle plate transverse direction). Further, among the nozzle rows 11Na and 11Nb having the N/2 nozzles 11, the nozzle row 11Na includes only the first sub-nozzle group SBN1, and the nozzle row 11Nb includes only the second sub-nozzle group SBN2.

In the third embodiment, as in the first and second embodiments, multiple heads 101a and 101b can be arranged in one row in the longitudinal direction as illustrated in FIG. 15, and the same advantageous effects as those of the first and second embodiments can be obtained.

Furthermore, in the third embodiment, the inclination of the head 101 (nozzle plate 10) is increased so that the nozzles 11 can be arranged further inward from the end portion of a head module 1. That is, the nozzles 11 can be arranged away from the end of the head module 1. Therefore, if an external impact is applied to the end of the head module 1, the impact can be more hardly transmitted to the nozzles, the pressure chamber, the flow paths, and the like.

### Fourth Embodiment

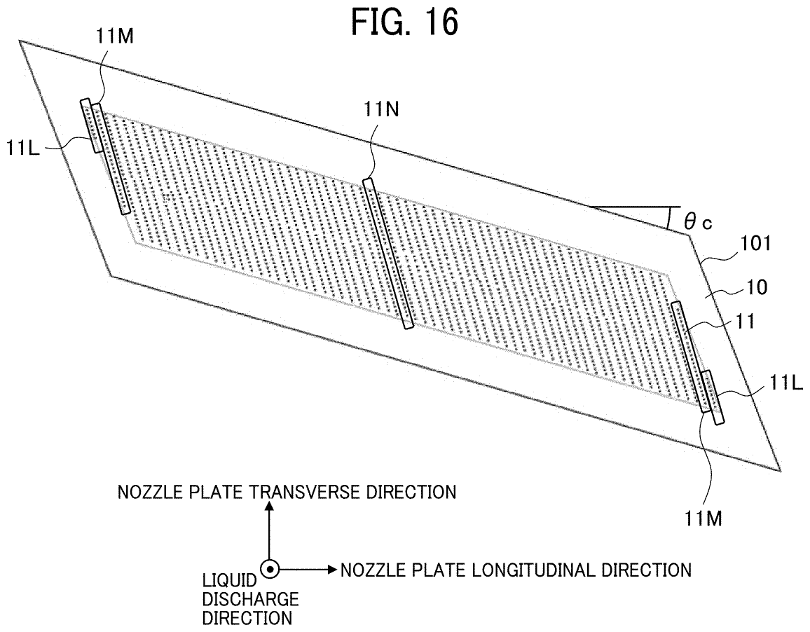

Next, a configuration of a fourth embodiment will be described with reference to FIG. 16, FIG. 16 is a bottom view of a main part of a head according to the fourth embodiment:

Although a head 101 in the third embodiment has nozzle rows 11N divided into a first sub-nozzle group SBN1 and a second sub-nozzle group SBN2, the nozzle rows 11N may not be divided as illustrated in FIG. 16. That is, the P number of sub-nozzle groups may be set to 1. In this case, the nozzles 11 are arranged side by side at equal spacings in the nozzle rows 11N, 11M, and 11L.

Regarding the arrangement of the nozzles 11, the nozzle rows 11N having N nozzles 11 in one row are arranged near the center in the direction in which the multiple nozzle rows is arranged (longitudinal direction). The nozzles 11 are arranged such that the number of nozzles decreases from the region near the center toward both end portions, such as the nozzle rows 111 having M(<N) nozzles 11 and the nozzle rows 11L, having N-M nozzles 11.

In the case of the fourth embodiment, as in the third embodiment, the multiple heads 101 can be arranged in one row in the direction orthogonal to the medium feeding direction, and the same advantageous effects as those of the third embodiment can be obtained.

### Fifth Embodiment

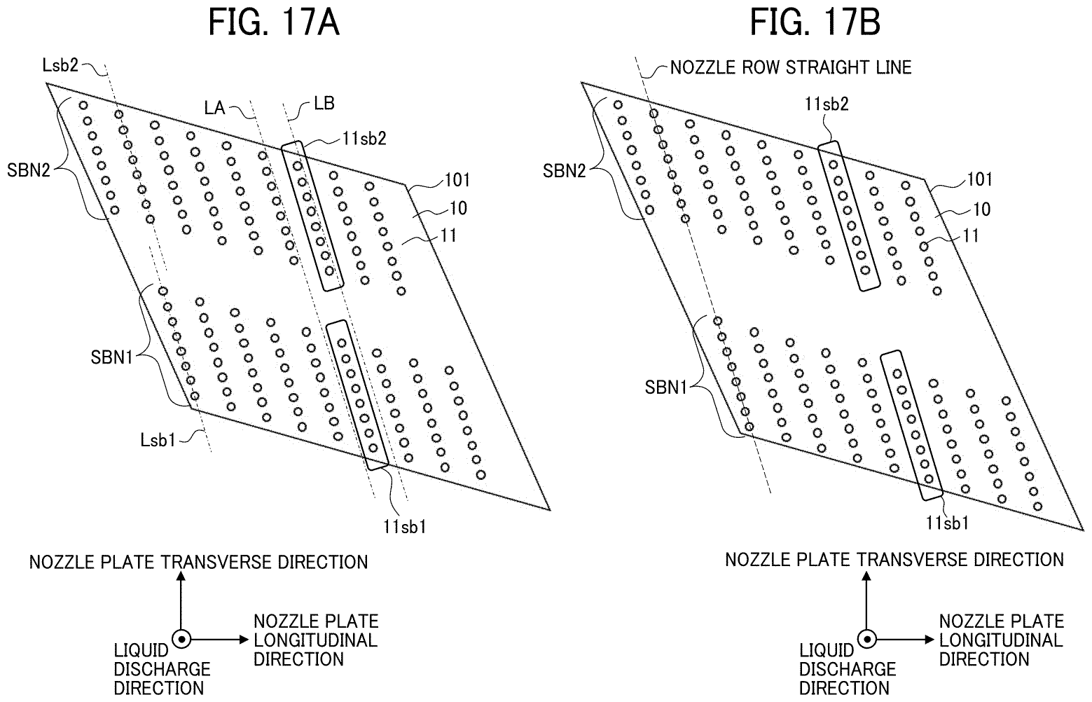

Next, a configuration of a fifth embodiment will be described with reference to FIGS. 17A and 17B. FIGS. 17A and 17B are schematic bottom views of a head according to the fifth embodiment.

For example, in the third embodiment, as illustrated in FIG. 17B, the first sub-nozzle rows 11sb1 forming the first sub-nozzle group SBN1 and the second sub-nozzle rows 11sb2 forming the second sub-nozzle group SBN2 are arranged to be substantially aligned on a nozzle row straight line. On the other hand, in the fifth embodiment, as illustrated in FIG. 17A, sub-nozzle rows are arranged such that a straight line Lsb1 passing through a first sub-nozzle row 11sb1 and a straight line Lsb2 passing through a second sub-nozzle row 11sb2 do not overlap each other.

That is, in the fifth embodiment, the second sub-nozzle row 11sb2 is not arranged on the straight line Lsb1 passing through the first sub-nozzle row 11sb1 and the second sub-nozzle row 11sb2 is arranged outside the straight line Lsb1 passing through the first sub-nozzle row 11sb1 positioned at the leftmost end in FIG. 17A. Conversely, at the right end, the first sub-nozzle row 11sb1 is arranged outside the second sub-nozzle row 11sb2.

The nozzle row 11N is defined as a row including nozzles (i), (ii), and (iii) described below
(i) Among the multiple nozzles 11 included in the first sub-nozzle group SBN1 and the second sub-nozzle group SBN2, nozzle in the first sub-nozzle row 11sb1 on one straight line (that is, a straight line passing through the nozzle in the first sub-nozzle row 11sb1 in FIG. 17A) included in the nozzle row straight line group.
(ii) Nozzles positioned on an intermediate line LB and adjacent to each other on the first axis positive side in the longitudinal direction as viewed from the one straight line or nozzles positioned closer to the one straight line than the intermediate line LB (that is, the nozzles in the second sub-nozzle row 11sb2 in FIG. 17A).
(iii) Nozzles positioned closer to the one straight line than an intermediate line LA and adjacent to each other on the first axis negative side as viewed from the one straight line (no corresponding nozzles in FIG. 17A).

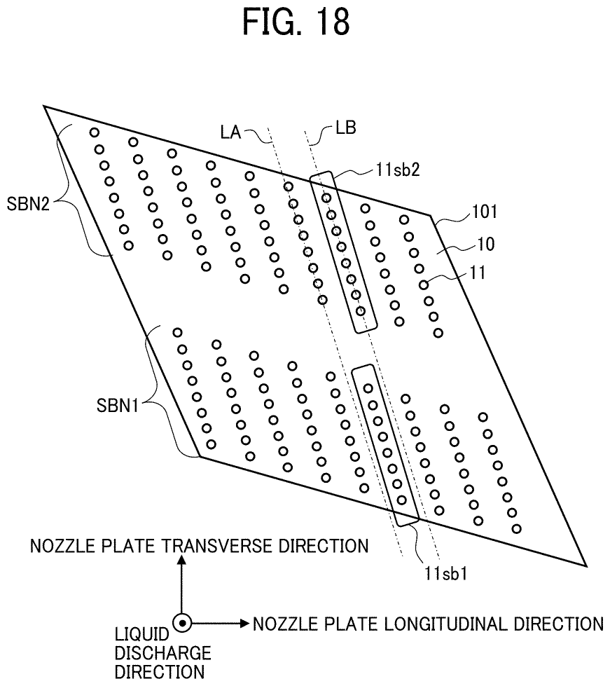

As illustrated in FIG. 18, if two second sub-nozzle rows 11sb2 are positioned on the two intermediate lines LA and LB, the nozzle row 11N is defined as a row including nozzles (i), (ii), and (iii) described below
(i) Among the multiple nozzles 11 included in the first sub-nozzle group SBN1 and the second sub-nozzle group SBN2, nozzle in the first sub-nozzle row 11sb1 on one straight line (that is, a straight line passing through the nozzle in the first sub-nozzle row 11sb1 in FIG. 18) included in the nozzle row straight line group.
(ii) Nozzles positioned on an intermediate line LB and adjacent to each other on the first axis positive side in the longitudinal direction as viewed from the one straight line or nozzles positioned closer to the one straight line than the intermediate line LB (that is, the nozzles in the second sub-nozzle row 11sb2 in FIG. 18).
(iii) Nozzles positioned closer to the one straight line than an intermediate line LA and adjacent to each other on the first axis negative side as viewed from the one straight line (no corresponding nozzles in FIG. 18).

The nozzle row defined as above is arranged on the nozzle plate 10, as a nozzle row having N nozzles in a region near the center of the nozzle plate in the longitudinal direction, as a nozzle row having less than N (N/2) nozzles at a first end of the nozzle plate on a first end side with respect to the region near the center in the longitudinal direction, and as a nozzle row having (N/2) nozzles at a second end of the nozzle plate on a second end side opposite to the first end side with respect to the region near the center in the longitudinal direction.

As a result, as in the first embodiment, it is possible to provide a liquid discharge head that has excellent robustness and can reduce damage due to an external impact. With the above configuration, in addition to the advantageous effects of the third embodiment, the distance between the first sub-nozzle group SBN1 and the second sub-nozzle group SBN2 can be arbitrarily set, which increases the degree of freedom in design.

The fifth embodiment is not limited to the nozzle arrangement illustrated in FIGS. 17A, 17B, and 18, and may be appropriately changed within the scope of the definition of the nozzle row described with reference to FIGS. 6 and 7.

In the embodiments described above, the head unit 555 is formed by arranging multiple heads 101 each including one nozzle plate 10. However, the number of nozzle plates 10 provided in one head 101 is not necessarily one. For example, one head 101 may include multiple nozzle plates 10, and the multiple nozzle plates 10 may be provided side by side in the one head 101 in the longitudinal direction.

Even in the above configuration, if the head 101 receives an impact from the outside, the impact is less likely to be transmitted to the nozzles, the pressure chamber, the flow paths, and the like, and the head 101 can be prevented from being damaged.

[Modifications]

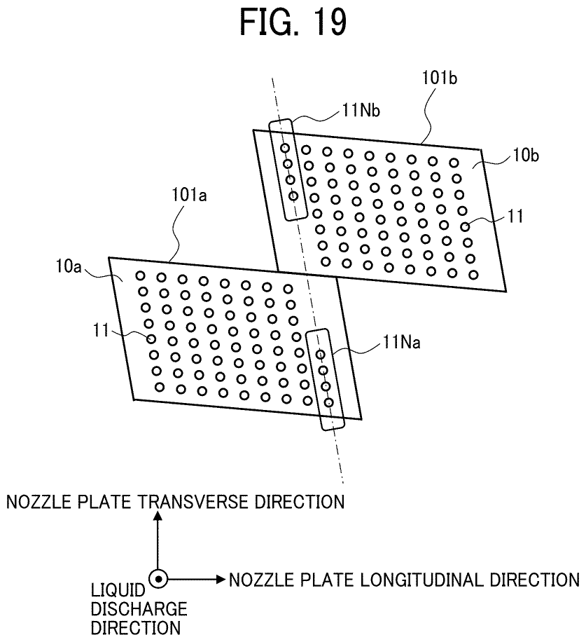

Next, modifications of the present embodiment will be described with reference to FIG. 19. FIG. 19 is a schematic bottom view of heads, which illustrates a modification.

In each of the above-described embodiments, the multiple heads 101 is arranged such that the ridgelines extending in the nozzle plate transverse direction are adjacent to each other. However, as illustrated in FIG. 19, the heads 101 may be arranged such that the ridgelines extending in the longitudinal direction are adjacent to each other.

According to the present modification, it is possible to obtain a sufficient spacing between a nozzle row 11Na at the right end portion of a head 101a and a nozzle row 11Nb at the left end portion of a head 101b, so that the head 101 can be enhanced in robustness against the impact on the end portion.

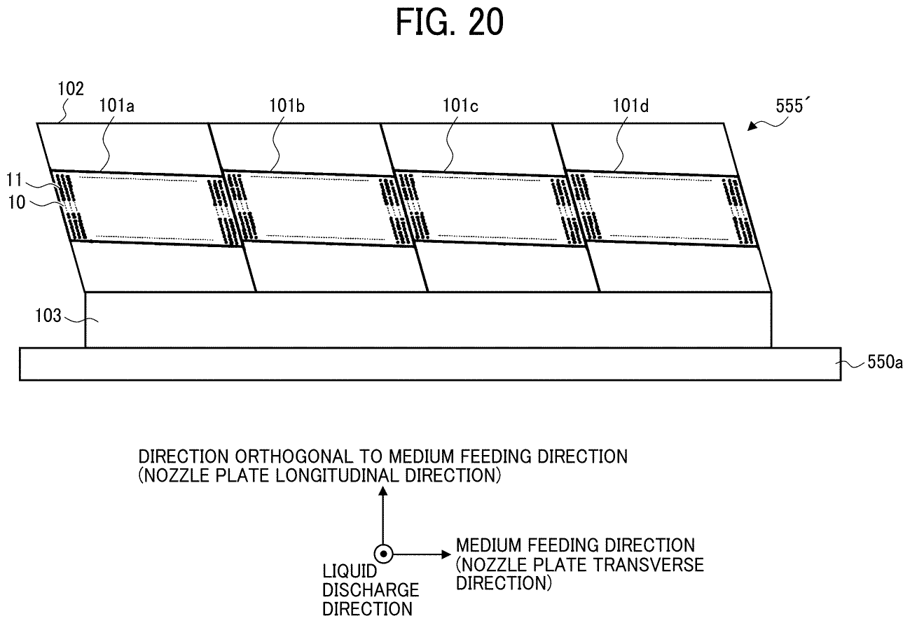

Next, a modification of the present embodiment will be described with reference to FIG. 20. FIG. 20 is a bottom view of a modification of the head unit.

The head unit 555 illustrated in FIG. 2 is configured by arranging multiple head modules 1a to 1d in the direction (longitudinal direction) orthogonal to the medium feeding direction. On the other hand, the head unit 555′ illustrated in FIG. 20 is configured as an integrated member without providing the head holding member 102 and the mount member 103 for each nozzle plate 10 (head 101). This produces an advantageous effect that at least some of the flow paths and the wirings can be shared among the multiple nozzle plates 10, for example.

### APPLICATION EXAMPLES

### Application Example 1

The liquid discharge head of the present embodiment can also discharge a liquid used to form a three-dimensional object. An example of the liquid used for forming a three-dimensional object is a hydrogel forming material for forming a three-dimensional solid structure used for therapeutic procedure training. The hydrogel forming material contains water and a polymerizable monomer, preferably contains a mineral and an organic solvent, and further contains a polymerization initiator and other components as necessary. The polymerizable monomer is a compound having one or more unsaturated carbon-carbon bonds; and is preferably a polymerizable monomer that is polymerized by an active energy ray such as an ultraviolet ray or an electron beam.

Examples of the polymerizable monomer include a monofunctional monomer and a polyfunctional monomer. One type of the polymerizable monomer may be used alone, or two or more types of the polymerizable monomers may be used in combination. Examples of the polyfunctional monomer include a bifunctional monomer, a trifunctional monomer, and a tetra- or higher functional monomer.

The mineral is not limited in particular, and can be appropriately selected according to the purpose. However, since the hydrogel contains water as a main component, a clay mineral is preferable, a layered clay mineral that is uniformly dispersed at the level of primary crystals in water is further preferable, and a water-swellable layered clay mineral is more preferable.

Examples of the organic solvent include water-soluble organic solvents. The water solubility of the water-soluble organic solvent means that the organic solvent can be dissolved in water in an amount of 30 mass % or more. The water-soluble organic solvent is not limited in particular, and can be appropriately selected according to a purpose. Examples of the water-soluble organic solvent include alkyl alcohols having 1 to 4 carbon atoms, such as methyl alcohol, ethyl alcohol, n-propyl alcohol, isopropyl alcohol, n-butyl alcohol, sec-butyl alcohol, and tert-butyl alcohol; amides such as dimethylformamide and di methylacetamide; ketones or ketone alcohols such as acetone, methyl ethyl ketone, and diacetone alcohol; ethers such as tetrahydrofuran and dioxane, polyhydric alcohols such as ethylene glycol, propylene glycol, 1,2-propanediol, 1,2-butanediol, 1,3-butanediol, 1,4-butanediol, diethylene glycol, triethylene glycol, 1,2,6-hexanetriol, thioglycol, hexylene glycol, and glycerin; poly alkylene glycols such as polyethylene glycol and polypropylene glycol; lower alcohol ethers of polyhydric alcohols such as ethylene glycol monomethyl (or ethyl) ether, diethylene glycol methyl (or ethyl) ether, and tri ethylene glycol monomethyl (or ethyl) ether; alkanol amines such as monoethanolamine, diethanolamine, and triethanolamine; N-methyl-2-pyrrolidone; 2-pyrrolidone; 1,3-dimethyl-2-imidazolidinone; and the like.

One type of the water-soluble organic solvent may be used alone, or two or more types of the water-soluble organic solvents may be used in combination. Among the water-soluble organic solvents, a polyvalent alcohol, glycerin, and propylene glycol are preferable, and glycerin and propylene glycol are more preferable from the viewpoint of moisture retaining property.

The polymerization initiator is not limited in particular, and can be appropriately selected according to the purpose. Examples of the polymerization initiator include a photopolymerization initiator and a thermal polymerization initiator. As the photopolymerization initiator, any substance that generates radicals by irradiation with light (in particular, ultraviolet rays having a wavelength of 220 nm to 400 nm) can be used. In the case of forming a three-dimensional object by using a hydrogel forming material; an ultraviolet (UV) irradiation mechanism is provided; and the discharged hydrogel forming material is cured by UV irradiation.

### Specific Example of Hydrogel Forming Material

While 120.0 parts by mass of ion-exchanged water having undergone vacuum degassing is stirred for 30 minutes, 12.0 parts by mass of synthetic hectorite (Laponite® XLG, manufactured by Rockwood Additives Ltd.) having a composition of [Mg 5.34 L1 0.66 Si8O 20 (OH) 4] Na −0.66 as a layered clay mineral was added little by little to the ion-exchanged water and stirred. Further, 0.6 parts by mass of etidronic acid (manufactured by Tokyo Chemical Industry Co., Ltd.) was added and stirred to prepare a dispersion liquid. To the obtained dispersion liquid were added 44.0 parts by mass of acryloylmorpholine (manufactured by KJ Chemicals Corporation) from which a polymerization inhibitor had been removed by passing through a column of activated alumina as a polymerizable monomer, and 0.4 parts by mass of methylene bisacrylamide (manufactured by Tokyo Chemical Industry Co., Ltd.). Further, 20.0 parts by mass of glycerin (manufactured by Sakamoto Yakuhin Kogyo Co., Ltd.) and 0.8 parts by mass of N, N, N′, N′-tetramethylethylenediamine (manufactured by Tokyo Chemical Industry Co., Ltd) were mixed to obtain a hydrogel forming material.

### Application Example 2

The liquid discharge head of the present embodiment can also be used with an inkjet method for arbitrarily arranging cells in order to artificially form a tissue body composed of cells, and can discharge a cell suspension liquid (cell ink). The cell suspension liquid (cell ink) contains at least cells and a cell desiccation inhibitor. Furthermore, the cell suspension liquid (cell ink) contains a dispersion medium for dispersing cells, and may contain other additive materials such as a dispersant and a pH adjusting agent as necessary.

The type and the like of the cells are not limited in particular, and can be appropriately selected according to the purpose. Every type of cells can be used taxonomically regardless of eukaryotic cells, prokaryotic cells, multicellular biological cells, and unicellular biological cells, for example. One type of the cells may be used alone, or two or more types of the cells may be used in combination.

Examples of the eukaryotic cells include animal cells, insect cells, plant cells, and fungi. These may be used singly or in combination of two or more kinds thereof. Among eukaryotic cells, animal cells are preferable. If the cells form a cell assembly, adhesive cells are more preferable because adhesive cells have cell adhesiveness to such an extent that the cells adhere to each other and are not isolated unless a physicochemical treatment is performed.

Examples of the cell desiccation inhibitor include proteins selected from polyhydric alcohols, gel-like polysaccharides, and extracellular matrices, which have a function of covering the surface of cells and suppressing desiccation of cells.

As the dispersion medium, a medium for cell culture or a buffer solution is preferable. The medium is a solution that contains components necessary for the formation and maintenance of cell tissue bodies, prevents drying, and conditions an external environment such as osmotic pressure, and any medium known as a medium can be appropriately selected and used. When it is not needed to constantly immerse the cells in the medium solution, the medium can be appropriately removed from the cell suspension liquid. The buffer solution is for adjusting the pH according to cells and purposes, and a known buffer solution can be appropriately selected and used.

### Specific Examples of Cell Suspension (Cell Ink)

Green fluorescent dye (trade name: Cell Tracker Green, manufactured by Life Technologies Corporation) was dissolved in dimethyl sulfoxide (hereinafter referred to as “DMSO”) at a concentration of 10 mmol/L (μM), and mixed with a serum-free Dulbecco's modified Eagle's medium (manufactured by Life Technologies Corporation)) to prepare a green fluorescent dye-containing serum-free medium having a concentration of 10 μmol/L (μM). Next, 5 mL of a green fluorescent dye-containing serum-free medium was added to a dish of the cultured NIH/3T3 cells (Clone 5611, JCRB Cell Bank), and the cells were cultured in an incubator (KM-CC 17 RU2 from Panasonic Corporation, 37° C., 5 vol % CO2 environment) for 30 minutes. The supernatant was then removed using an aspirator. To the dish was added 5 mL of phosphate buffered saline (manufactured by Life Technologies Corporation, hereinafter also referred to as PBS (—)), and PBS (—) was sucked and removed with an aspirator to wash the surface. The washing operation with PBS (—) was repeated two times, and then a 0.05 mass % trypsin-0.05 mass % EDTA solution (manufactured by life technologies Corporation) was added in an amount of 2 mL per dish.

Next, the dish was heated in an incubator for five minutes to detach the cells from the dish, and 4 mL of D-MEM containing 10 mass % fetal bovine serum (hereinafter, also referred to as “FBS”) and 1 mass % antibiotic (Antibiotic-Antimycotic Mixed Stock Solution (100×), manufactured by Nacalai Tesque, Inc.) was then added. Next, the trypsin-deactivated cell suspension was transferred to one 50 mL centrifuge tube and centrifuged (trade name: FI-19 FM, manufactured by KOKUSAN Co., Ltd., 1,200 rpm, 5 minutes, 5° C.), and the supernatant was removed using an aspirator.

After removal, 2 mL of D-MEM containing 10 mass % FBS and 1 mass % antibiotic was added to the centrifuge tube, and gently pipetted to disperse the cells; thereby obtaining a cell suspension liquid. Then, 10 μL of the cell suspension was taken out into an Eppendorf tube, 70 μL of the culture medium was added thereto, then 10 μL of the cell suspension was taken out into another Eppendorf tube, and 10 μL of a 0.4 mass % trypan blue stain was added thereto to perform pipetting. Then, 10 μL, was removed from the stained cell suspension and placed on a PMMA plastic slide.

The number of cells was measured using Trade name: Countess Automated Cell Counter (manufactured by Invitrogen) to determine the number of cells, thereby obtaining a cell suspension liquid in which the number of cells was measured. PBS (−) was used as a dispersion medium. Glycerin (Molecular biology grade, manufactured by Wako Pure Chemical Industries, Ltd.) as a cell drying inhibitor was dissolved in PBS (−) at a mass ratio of 0.5 mass %, and the NIH/3T3 cell suspension liquid was dispersed in the dispersion medium at 6×106 cells/MI, to obtain cell ink.

The above-described applications are mere examples, and the present embodiment produces advantageous effects specific to each of the following aspects.

According to a first aspect, a nozzle plate is provided on which multiple nozzles discharging a liquid is arranged at the predetermined pitch (d) corresponding to a recording resolution in a longitudinal direction. The multiple nozzles is divided into P (P is an integer of 1 or more) sub-nozzle groups (for example, the first sub-nozzle group SBN1 and the second sub-nozzle group SBN2) including multiple sub-nozzles arranged at the spacing of (d×P) in the longitudinal direction. Each of the sub-nozzle groups has sub-nozzle rows for example, the sub-nozzle rows 11sb1 and 11sb2) including multiple sub-nozzles that is arranged at the spacing of (d×P) left in the longitudinal direction, in the longitudinal direction and the direction inclined with respect to the nozzle plate transverse direction orthogonal to the longitudinal direction. Assuming that a set of rows including the sub-nozzle rows of the P sub-nozzle groups, which are arranged in one line along the inclined direction, is defined as nozzle row (for example, the nozzle row 11N), the nozzle row having N nozzles is arranged in a region near the center of the nozzle plate in the longitudinal direction, the nozzle row (for example, the nozzle row 11N) having M nozzles, which is less than N nozzles, is arranged at a first end portion (left end portion the nozzle plate 10 in FIG. 10) of the nozzle plate which is closer to the first end portion than the region near the center in the longitudinal direction, and the nozzle row (for example, the nozzle row 11L) having (N-M) nozzles is arranged at a second end portion (right end portion the nozzle plate 10 in FIG. 10) of the nozzle plate which is closer to the second end portion opposite to the first end portion than the region near the center in the longitudinal direction.

According to the first aspect, it is possible to provide a liquid discharge head having excellent robustness and capable of reducing damage due to an external impact.

A second aspect is characterized in that, in the first aspect, a direction in which the nozzle rows are arranged (for example, the direction inclined at the angle θb with respect to the nozzle plate transverse direction) is different from a direction of ridgeline of the short side of the nozzle plate (for example, the direction inclined at the angle θa with respect to the nozzle plate transverse direction).

According to the second aspect, when the multiple nozzle plates (heads) is arranged in the longitudinal direction, the short sides of the ridgelines of the nozzle plates are arranged so as to cross between the M nozzles and the N-M nozzles. In this case, the M nozzles of one nozzle plate and the N-M nozzles of the other nozzle plate can be regularly arranged without greatly offsetting the two nozzle plates in the nozzle plate transverse direction orthogonal to the longitudinal direction. By arranging the two nozzle plates so that the short sides of the ridgelines thereof face each other, the size of the entire head can be reduced in the transverse direction. In addition, the distances from the nozzles at the end portions of the M nozzles to the short sides of the ridgelines and the distances from the nozzles at the end portions of the N nozzles to the short sides of the ridgelines can be secured in the transverse direction of the nozzle plate, and the nozzles at the end portions can be further prevented from being broken due to an external impact or the like.

A third aspect is characterized in that, in the first aspect or the second aspect, the multiple nozzle rows is arranged in a region having an outer shape of a substantially parallelogram.

According to the third aspect, the multiple nozzle plates can be regularly arranged to form a long head, and the size of the entire head can be reduced. Furthermore, the entire size of the head unit configured by arranging the multiple heads can be reduced.

A fourth aspect is characterized in that, in any one of the first to third aspects, the value of P is an integer of 2 or more, a first sub-nozzle group (for example, the first sub-nozzle group SBN1) and a second sub-nozzle group (for example, the second sub-nozzle group SBN2) are included as multiple sub-nozzle groups, and the nozzles are arranged such that the number of nozzles included in the sub-nozzle row of the first sub-nozzle group sequentially decreases from the region near the center toward the first end portion (for example, the left end portion of the nozzle plate 10 in FIG. 10), and after the number of nozzles included in the sub-nozzle row of the first sub-nozzle group becomes zero, the number of nozzles included in the sub-nozzle row of the second sub-nozzle group sequentially decreases.

According to the fourth aspect, including the two sub-nozzle groups makes it possible to enhance the recording resolution of the head as compared with a case where there is only one sub-nozzle group, and form the nozzle row including the same number of nozzles as the nozzles in the region near the center without arranging the nozzles up to almost the end of the head (nozzle plate).

A fifth aspect is characterized in that, in any one of the first to fourth aspects, the value of P is an integer of 2 or more, a first sub-nozzle group (for example, the first sub-nozzle group SBN1) and a second sub-nozzle group (for example, the second sub-nozzle group SBN2) are included as multiple sub-nozzle groups, and the nozzles are arranged such that the number of nozzles included in the sub-nozzle row of the second sub-nozzle group sequentially decreases from the region near the center toward the second end portion (for example, the right end portion of the nozzle plate 10 in FIG. 10), and after the number of nozzles included in the sub-nozzle row of the second sub-nozzle group becomes zero, the number of nozzles included in the sub-nozzle row of the first sub-nozzle group sequentially decreases.

According to the fifth aspect, including the two sub-nozzle groups makes it possible to enhance the recording resolution of the head as compared with a case where there is only one sub-nozzle group, and form the nozzle row including the same number of nozzles as the nozzles in the region near the center without arranging the nozzles up to almost the end of the head (nozzle plate).

A sixth aspect is characterized in that, in any one of the first to fifth aspects, assuming that N nozzles are arranged per row at the first end portion (for example, the left end portion of the nozzle plate 10 in FIG. 10) and the second end portion (for example, the right side end portion of the nozzle plate 10 in FIG. 10) on the same rule as that in the region near the center, that a region outside a short side of the ridgeline of the nozzle plate at the first end portion is defined as first chipped region (for example, the first chipped region A), and that a region outside the short side of the ridgeline of the nozzle plate at the second end portion is defined as second chipped region (for example, the second missing region B), at least some of N-M nozzles among the N nozzles assumed at the first end portion are in the first chipped region, and at least some of M nozzles among the N nozzles assumed at the second end portion are in the second chipped region.

According to the sixth aspect, it is possible to form a nozzle row including the same number of nozzles as those in the region near the center without arranging the nozzles up to almost the end of the head (nozzle plate).

A seventh aspect is characterized in that, in any one of the first to third aspects, the value of P is an integer of 2 or more, a first sub-nozzle group (for example, the first sub-nozzle group SBN1) and a second sub-nozzle group (for example, the second sub-nozzle group SBN2) are included as multiple sub-nozzle groups, a nozzle row having N nozzles is arranged in a region near a center in the longitudinal direction, and a nozzle row (for example, the nozzle rows 11Na and 11Nb) having N/2 nozzles including only the sub-nozzle row of the first sub-nozzle group or only the sub-nozzle row of the second sub-nozzle group is arranged at an end in the longitudinal direction.

Also in the seventh aspect, it is possible to provide a liquid discharge head that is excellent in robustness and is capable of reducing damage due to an external impact or the like. Furthermore, the entire size of the head unit configured by arranging the multiple heads can be reduced.

An eighth aspect is characterized in that, in any one of the first to seventh aspects, the liquid discharge head includes multiple the nozzle plates, and the multiple nozzle plates is provided side by side in the longitudinal direction.

According to the eighth aspect, for example, it is possible to simplify the configuration and increase the degree of freedom in design, such as sharing at least some of the flow paths and the wirings among the multiple nozzle plates.

[Aspect 9]

A liquid discharge head (101) includes: a nozzle plate (10) having multiple nozzles (11) arrayed at a predetermined pitch (d) corresponding to a recording resolution in a longitudinal direction of the nozzle plate (10), wherein the multiple nozzles (11) are divided into P number of sub-nozzle groups (SBN1, SBN2), each of the P number of sub-nozzle groups (SBN1, SBN2) including the multiple nozzles (11) as multiple sub-nozzles (11), where P is an integer of one or more, the multiple sub-nozzles (11) are arrayed in the longitudinal direction at a first interval of (d×P), each of the P number of sub-nozzle groups (SBN1, SBN2) includes sub-nozzle rows (11sb1, 11sb2) each including the multiple sub-nozzles (11) arrayed at the first interval of (d×P) in the longitudinal direction and in a first inclination direction inclined relative to the longitudinal direction and a transverse direction orthogonal to the longitudinal direction and a set of the sub-nozzle rows (11sb1, 11sb2) of the P number of the sub-nozzle groups (SBN1, SBN2) arrayed in one row in the first inclination direction form a nozzle row (11N), the nozzle row (11N) has N number of the multiple sub-nozzles (11) in a central region of the nozzle plate (10) in the longitudinal direction, the nozzle row (11M) has M number of the multiple sub-nozzles (11) less than the N number of the multiple sub-nozzles (11), the M number of the multiple sub-nozzles (11) arrayed at a first end portion of the nozzle plate (10) in the longitudinal direction, and the nozzle row (11L) having (N-M) number of the multiple sub-nozzles (11) at a second end portion opposite to the first end portion of the nozzle plate (10 across the central region in the longitudinal direction.

[Aspect 10]

In the liquid discharge head (101) according to aspect 9, a short side of the nozzle plate (10) is in a second inclination direction (θa) inclined relative to the longitudinal direction and the transverse direction, and the first inclination direction is different from the second inclination direction.

[Aspect 11]

In the liquid discharge head (101) according to aspect 10, the nozzle plate (10) has a nozzle region has a shape of a parallelogram, the nozzle plate (10) includes multiple nozzle rows (11N, 11M, 11L) including the nozzle row (11N, 11M, 11L) in the nozzle region, and the multiple nozzle rows (11N, 11M, 11L) are arrayed two-dimensionally in a third inclination direction different from the first inclination direction and the second inclination direction.

[Aspect 12]

In the liquid discharge head (101) according to any one of aspects 9 to 11, the P is an integer of two or more, the P number of sub-nozzle groups (SBN1, SBN2) includes a first sub-nozzle group (SBN1) and a second sub-nozzle group (SBN2) each including the multiple sub-nozzles (11), a number of the multiple sub-nozzles (11) in the sub-nozzle rows (11sb1, 11sb2) of the first sub-nozzle group (SBN1) sequentially decreases from the central region toward the first end portion, and a number of the multiple sub-nozzles (II) in the sub-nozzle rows (11sb2) of the second sub-nozzle group (SBN2) sequentially decreases from the central region toward the first end portion after the number of the multiple sub-nozzles (11) in the sub-nozzle rows (11sb1) of the first sub-nozzle group (SBN1) becomes zero.

[Aspect 13]

In the liquid discharge head (101) according to any one of aspects 9 to 12, the P is an integer of two or more, the P number of sub-nozzle groups (SBN1, SBN2) includes a first sub-nozzle group (SBN1) and a second sub-nozzle group (SBN2), and a number of the multiple sub-nozzles (11) in the sub-nozzle rows (11sb2) of the second sub-nozzle group (SBN2) sequentially decreases from the central region toward the second end portion, and a number of the multiple sub-nozzles (11) in the sub-nozzle rows (11sb1) of the first sub-nozzle group (SBN) sequentially decreases from the central region toward the second end portion after the number of the multiple sub-nozzles (11) in the sub-nozzle rows (11sb2) of the second sub-nozzle group (SBN2) becomes zero.

[Aspect 14]

In the liquid discharge head (101) according to any one of aspects 9 to 13, the nozzle plate (10) has a nozzle region has a shape of a parallelogram, the nozzle plate (10) includes multiple nozzle rows (11N, 11M, 11L) including the nozzle row (11N, 11M, 11L) in the nozzle region, and the first end portion includes one corner of the nozzle region having an acute angle, the first end portion including the nozzle row (11M) having the M number of the multiple sub-nozzles (11), and the second end portion includes another corner of the nozzle region having the acute angle, the second end portion including the nozzle row (11L) having the (N-M) number of the multiple sub-nozzles (11).

[Aspect 15]

In the liquid discharge head (101) according to any one of aspects 9 to 11, the P is an integer of two or more, the P number of sub-nozzle groups (SBN1, SBN2) includes a first sub-nozzle group (SBN1) and a second sub-nozzle group (SBN2), and the central region includes the nozzle row (11N) having the N number of the multiple sub-nozzles (11), the first end portion includes the nozzle row (11M) having the N/2 number of the multiple sub-nozzles (11) of the first sub-nozzle group (SBN1), and the second end portion includes the nozzle row (11L) having the N/2 number of the multiple sub-nozzles (11) of the second sub-nozzle group (SBN2).

[Aspect 16]

In the liquid discharge head (101) according to any one of aspects 9 to 15, further includes multiple nozzle plates (10) including the nozzle plate (10), and the multiple nozzle plates (10) are arrayed in the longitudinal direction.

[Aspect 17]

A liquid discharge unit (555) includes multiple liquid discharge heads (101) including the liquid discharge head (101) according to any one of aspects 1 to 7 arrayed in the longitudinal direction.

[Aspect 18]

A liquid discharge apparatus (500) includes the liquid discharge head (101) according to any one of aspects 9 to 16 or the liquid discharge unit (555) according to aspect 15.

In the embodiments of the present embodiment described above, constituent elements may be appropriately changed, added, and deleted without departing from the gist of the present embodiment. The present embodiment is not limited to the embodiments described above, and many modifications may be made by a person having ordinary knowledge in the field within the technical idea of the present embodiment.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having multiple nozzles arrayed at a predetermined pitch (d) corresponding to a recording resolution in a longitudinal direction of the nozzle plate,
wherein the multiple nozzles are divided into P number of sub-nozzle groups, each of the P number of sub-nozzle groups including the multiple nozzles as multiple sub-nozzles, where P is an integer of one or more,
the multiple sub-nozzles are arrayed in the longitudinal direction at a first interval of (d×P),
each of the P number of sub-nozzle groups includes sub-nozzle rows each including the multiple sub-nozzles arrayed at the first interval of (d×P) in the longitudinal direction and in a first inclination direction inclined relative to the longitudinal direction and a transverse direction orthogonal to the longitudinal direction, and
a set of the sub-nozzle rows of the P number of the sub-nozzle groups arrayed in one row in the first inclination direction form a nozzle row,
the nozzle row has N number of the multiple sub-nozzles in a central region of the nozzle plate in the longitudinal direction,
the nozzle row has M number of the multiple sub-nozzles less than the N number of the multiple sub-nozzles, the M number of the multiple sub-nozzles arrayed at a first end portion of the nozzle plate in the longitudinal direction, and
the nozzle row having (N-M) number of the multiple sub-nozzles at a second end portion opposite to the first end portion of the nozzle plate across the central region in the longitudinal direction.

2. The liquid discharge head according to claim 1,
wherein a short side of the nozzle plate is in a second inclination direction inclined relative to the longitudinal direction and the transverse direction, and
the first inclination direction is different from the second inclination direction.

3. The liquid discharge head according to claim 2,
wherein the nozzle plate has a nozzle region has a shape of a parallelogram,
the nozzle plate includes multiple nozzle rows including the nozzle row in the nozzle region, and
the multiple nozzle rows are arrayed two-dimensionally in a third inclination direction different from the first inclination direction and the second inclination direction.

4. The liquid discharge head according to claim 1,
wherein the P is an integer of two or more,
the P number of sub-nozzle groups includes a first sub-nozzle group and a second sub-nozzle group each including the multiple sub-nozzles,
a number of the multiple sub-nozzles in the sub-nozzle rows of the first sub-nozzle group sequentially decreases from the central region toward the first end portion, and
a number of the multiple sub-nozzles in the sub-nozzle rows of the second sub-nozzle group sequentially decreases from the central region toward the first end portion after the number of the multiple sub-nozzles in the sub-nozzle rows of the first sub-nozzle group becomes zero.

5. The liquid discharge head according to claim 1,
wherein the P is an integer of two or more,
the P number of sub-nozzle groups includes a first sub-nozzle group and a second sub-nozzle group, and
a number of the multiple sub-nozzles in the sub-nozzle rows of the second sub-nozzle group sequentially decreases from the central region toward the second end portion, and
a number of the multiple sub-nozzles in the sub-nozzle rows of the first sub-nozzle group sequentially decreases from the central region toward the second end portion after the number of the multiple sub-nozzles in the sub-nozzle rows of the second sub-nozzle group becomes zero.

6. The liquid discharge head according to claim 1,
wherein the nozzle plate has a nozzle region has a shape of a parallelogram,
the nozzle plate includes multiple nozzle rows including the nozzle row in the nozzle region, and
the first end portion includes one corner of the nozzle region having an acute angle, the first end portion including the nozzle row having the M number of the multiple sub-nozzles, and
the second end portion includes another corner of the nozzle region having the acute angle, the second end portion including the nozzle row having the (N-M) number of the multiple sub-nozzles.

7. The liquid discharge head according to claim 1,
wherein the P is an integer of two or more,
the P number of sub-nozzle groups includes a first sub-nozzle group and a second sub-nozzle group, and
the central region includes the nozzle row having the N number of the multiple sub-nozzles,
the first end portion includes the nozzle row having N/2 number of the multiple sub-nozzles of the first sub-nozzle group, and
the second end portion includes the nozzle row having the N/2 number of the multiple sub-nozzles of the second sub-nozzle group.

8. The liquid discharge head according to claim 1, further comprising multiple nozzle plates including the nozzle plate, and
the multiple nozzle plates are arrayed in the longitudinal direction.

9. A liquid discharge unit comprising multiple liquid discharge heads including the liquid discharge head according to claim 1 arrayed in the longitudinal direction.

10. A liquid discharge apparatus comprising the liquid discharge head according to claim 1.

11. A liquid discharge apparatus comprising the liquid discharge unit according to claim 9.
